(19) United States
(12) Patent Application Publication
(10) Pub. No.: US 2008/0159375 A1
(43) Pub. Date: Jul. 3, 2008

(54) Method of enhanced detection technique for wireless MIMO communication system

(75) Inventors: Seog-Hong Park, Seoul (KR); Myung-Sun Baek, Seoul (KR); Bon-Wook Koo, Seoul (KR); Hyoung-Kyu Song, Seongnam-si (KR)

Correspondence Address: RATNERPRESTIA, P O BOX 980, VALLEY FORGE, PA, 19482-0980, US

(73) Assignee: MewTel Technology Inc., Seoul (KR)

(21) Appl. No.: 11/646,963

(22) Filed: Dec. 28, 2006

(51) Int. Cl. H04L 27/01

(52) U.S. Cl. 375/233

(57) ABSTRACT

A method of enhanced detection technique is used with wireless MIMO communication system. Since the performance of V-BLAST system depends on the first sub-stream detection capability, V probable streams are detected according to the first detected sub-stream of DFE detector and most probable stream is selected by likelihood test. The performance of the V-BLAST system can be improved and the decoding complexity and system performance can be controlled by adjusting the number of V.

### FIELD OF THE INVENTION

The present invention relates to a method of detection in a MIMO (multiple input multiple output) system. More particularly, the present invention relates a method of detecting the MIMO signal with combined structure of ML detection and DFE detection. The performance of the V-BLAST system can be improved by adopting this present invention, and the decoding complexity and system performance can be controlled by adjusting the number of V.

### BACKGROUND OF THE INVENTION

In the V-BLAST system with Nₜ transmitting and Nᵣ receiving antennas, the signal S=[S₁ S₂ . . . S_{N}_{ₜ}] is transmitted by using Nₜ transmitting antennas. Then the receive signal vector is given by

Y=HS+w.

where H is Nₜ×Nᵣ channel matrix, and w is zero-mean Gaussian noise with variance ρ_{w}².

ML detection and decoding correspond to choosing the codeword S which determines the symbol combination with the smallest distance metric as a decision value. Theoretically, ML detection would be the optimum way of recovering the transmitted data at the receiver. But as the computational effort is of order L^{N}^{ₜ} in L-QAM system with Nₜ transmitting antennas, ML detection is not feasible for real time implementations. Therefore, suboptimum detection schemes are generally used.

The representative and general detection scheme is OSIC detection scheme. In the OSIC detector, the received signal vector Y is multiplied by filter matrix G which is the Moore-Penrose pseudo-inverse denoted by (k)* of the channel matrix. With the definition of a (Nₜ+Nᵣ)Nₜ extended channel matrix

$$\underline{H} = [ \begin{matrix}H \\ {σ}_{w} {I}_{{N}_{t}}\end{matrix} ] ,$$

the MMSE filter can be written as follows

G_{MMSE}=(H^{H}H)⁻¹H^{H}.

Assume that sub-stream i yields the smallest estimation error or, equivalently, the largest signal-to-noise ratio (SNR) after linear nulling of the interference. It can be concluded that this sub-stream is associated with the row g⁽ⁱ⁾ of G that has minimum Euclidean norm, because this vector brings out the smallest noise enhancement. So, during the first step of the algorithm, only the decision static

Ŝᵢ=g⁽ⁱ⁾Y=g⁽ⁱ⁾(HS+w)=Sᵢ+ηᵢ

with the effective noise ηᵢ=g⁽ⁱ⁾w is used to find an estimate Ŝᵢ for the transmit signal Sᵢ.

This detection procedure consisting of nulling and cancelling is repeated for the reduced system until all signals are detected. In this procedure, the pseudo-inverse matrix calculation of the channel matrix is required in every layer detection.

To reduce the decoding complexity, simple DFE detector based on QR decomposition is proposed. In the sorted MMSE QR decomposition, the ∥G_{MMSE}∥² is calculated and sorted from the smallest to the largest. The sorted indexes are saved in sequence k, k=[k₁ k₂ . . . k_{N}_{ₜ}]. The columns of channel matrix H are rearranged according the sorted index sequence k. The QR decomposition of rearrange channel matrix Hₛₒᵣₜ is executed: Hₛₒᵣₜ=QR, where Q is an orthonormal matrix satisfied with Q^{H}Q=I.

Using the nulling vector, the Nₜ×1 output vector can be expressed as

$$Z = {Q}^{H} Y = RS + η = [ \begin{matrix}{r}_{1 , 1} & {r}_{1 , 2} & ⋯ & {r}_{1 , {N}_{t}} \\ 0 & {r}_{2 , 2} & ⋯ & {r}_{2 , {N}_{t}} \\ ⋮ & ⋮ & ⋰ & ⋮ \\ 0 & 0 & ⋯ & {r}_{{N}_{t} , {N}_{t}}\end{matrix} ] [ \begin{matrix}{S}_{{k}_{1}} \\ {S}_{{k}_{2}} \\ ⋮ \\ {S}_{{k}_{{N}_{t}}}\end{matrix} ] + [ \begin{matrix}{η}_{1} \\ {η}_{2} \\ ⋮ \\ {η}_{{N}_{t}}\end{matrix} ] ,$$

where η=Q^{H}w. The detected signal

$$S = ( {S}_{{k}_{1}} {S}_{{k}_{2}} … {S}_{{k}_{{N}_{t}}} )$$

is rearranged according to the order of transmit antenna by using index sequence k.

The existing suboptimum techniques have not reached the available capacities. In particular, there is a wide gap between the performance obtained by suboptimum detection algorithm of V-BLAST and optimum performance algorithms.

### SUMMARY OF THE PREFERRED EMBODIMENTS

The present invention has been made in an effort to overcome the limitation of above MIMO detection schemes.

It is an object of the present invention to provide a method of MIMO signal detection which guarantees reliable signal detection performance and high throughput.

To achieve the object, the present invention uses above MIMO detection schemes (ML and DFE). In the present invention, the DFE decoding is firstly executed and then the final detecting signal is determined by ML test.

In the present invention, since the performance of V-BLAST system highly depends on the first sub-stream detection capability, V probable streams are detected according to the first detected sub-streams of DFE detector and most probable stream is selected by likelihood test. The present invention consists of three steps as shown in FIG. 2. In first step, V sub-streams are detected, which are first outputs of DFE detector. Next, V streams are detected according to the detected V sub-streams in first step. In this step, the DFE decoding process is executed V times. In final step, most probable stream among V streams in second step is selected by likelihood test.

The performance of the V-BLAST system can be improved by adopting this present invention, and the decoding complexity and system performance can be controlled by adjusting the number of V.

### BRIEF DESCRIPTION OF THE DRAWINGS

Further objects and other advantages of the present invention will become apparent from the following description in conjunction with the attached drawings, in which:

FIG. 1 is a block diagram of a V-BLAST.

FIG. 2 is a block diagram of a MIMO-receiver with the method of enhanced detection.

FIG. 3 is Process of decision function, Q^{(V)}(k), when V=4.

FIG. 4 is result of detected V streams according to first detected V sub-stream.

FIG. 5 is BER performance of enhanced detection in MIMO-system with Nₜ=Nᵣ=3 according to the number of V.

FIG. 6 is BER performance of enhanced detection in MIMO-system with Nₜ=Nᵣ=2, 4 and 8 according to the number of V.

### DETAILED DESCRIPTION OF THE PREFERRED EMBODIMENTS

Preferred embodiments of the present invention will now be described in detail with reference to the accompanying drawings.

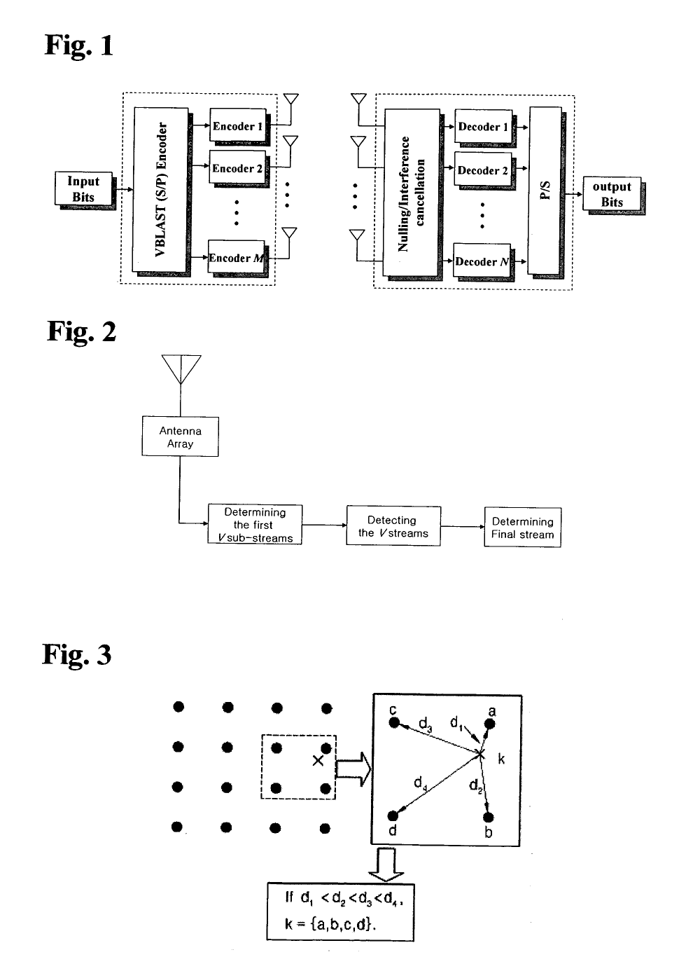

A V-BLAST systems with Nₜ transmit and Nᵣ receive antennas is considered as shown in FIG. 1. Because the symbols are transmitted from Nₜ transmit antennas in parallel, the Nₜ×1 data sequence matrix is S=[S₁ S₂ . . . S_{N}_{ₜ}]^{T}.

The overall channel H can be represented as Nᵣ×Nₜ complex matrix and the received baseband signal at j-th receiving antenna is

$${Y}_{j} = {\sum }_{i = 1}^{{N}_{t}} {H}_{ji} {S}_{i} + {w}_{j} \qquad [ Equation 1 ]$$

where Hⱼᵢ is channel element with i-th transmit antenna and j-th receiving antenna, and wⱼ is zero-mean Gaussian noise with variance σ_{w}².

The invention is consists of three steps.

STEP 1. Detecting V sub-streams at the first detection order of sorted DFE detector: The first detected sub-stream of QR-decomposition can be presented as follows

$${\hat{S}}_{{k}_{{N}_{t}}} = {Z}_{{N}_{t}} / {r}_{{N}_{t} , {N}_{t}} = ( {r}_{{N}_{t} , {N}_{t}} \cdot {S}_{{k}_{{N}_{t}}} + {η}_{{N}_{t}} ) / {d}_{{N}_{t} , {N}_{t}} , \qquad [ Equation 2 ]$$

and V probable sub-streams are determined. It can be expressed as follows

$${\hat{S}}_{{k}_{{N}_{t}}} = {Q}^{( V )} ( {\hat{S}}_{{k}_{{N}_{t}}} ) , \qquad [ Equation 3 ]$$

where Q^{(V)}(k) is decision function which determines V symbols of M-QAM system (VεM) by checking the Euclidean distance from K to each symbol, and

$${S}_{{k}_{{N}_{t}}} = [ {\hat{S}}_{{k}_{{N}_{t}}}^{( 1 )} , … , {\hat{S}}_{{k}_{{N}_{t}}}^{( v )} , … , {\hat{S}}_{{k}_{{N}_{t}}}^{( V )} ]$$

where

$${\hat{S}}_{{k}_{{N}_{t}}}^{( v )}$$

is ν-th estimated symbol whose Euclidean distance from

$${\hat{S}}_{{k}_{{N}_{t}}}$$

is ν-th. FIG. 3 shows the process of Q^{(V)}(k) when V=4.

STEP 2. Determining V streams by using sorted DFE detector according to detected V sub-streams of step 1:

$$\begin{matrix}{\hat{S}}_{{k}_{{N}_{t} - 1}}^{( 1 )} = Q [ ( {z}_{{N}_{t} - 1} - {r}_{2 , {N}_{t}} {\hat{S}}_{{k}_{{N}_{t}}}^{( 1 )} ) / {r}_{{N}_{t} - 1 , {N}_{t } - 1} ] , … \\ {\hat{S}}_{{k}_{1}}^{( 1 )} = Q [ ( {z}_{1} - {\sum }_{i = 2}^{{N}_{t}} {r}_{1 , i} {\hat{S}}_{{k}_{i}}^{( 1 )} ) / {r}_{1 , 1} ] , \\ ⋮ \\ {\hat{S}}_{{k}_{{N}_{t} - 1}}^{( V )} = Q [ ( {z}_{{N}_{t} - 1} - {r}_{2 , {N}_{t}} {\hat{S}}_{{k}_{{N}_{t}}}^{( V )} ) / {r}_{{N}_{t} - 1 , {N}_{t} - 1} ] , … \\ {\hat{S}}_{{k}_{1}}^{( V )} = Q [ ( {z}_{1} - {\sum }_{i = 2}^{{N}_{t}} {r}_{1 , i} {\hat{S}}_{{k}_{i}}^{( V )} ) / {r}_{1 , 1} ] .\end{matrix} \qquad [ Equation 4 ]$$

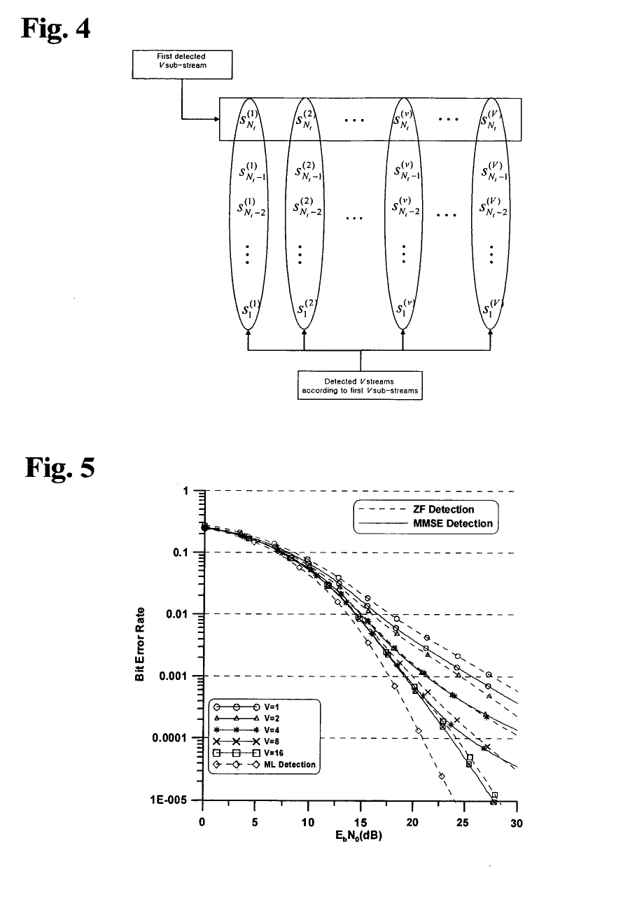

This process is shown in FIG. 4. There are first detected sub-streams of step 1 in the square of FIG. 3.

The all detected signals Ŝ=[Ŝ^{(I)}, . . . , Ŝ^{(V)}] are rearranged according to the order of transmit antenna by using index sequence k, where

$${\hat{S}}^{( v )} = [ {\hat{S}}_{{k}_{1}}^{( v )} {\hat{S}}_{{k}_{2}}^{( v )} … {\hat{S}}_{{k}_{{N}_{t}}}^{( v )} ] .$$

STEP 3. Selecting the most probable stream among V streams in step 2: In this step, final stream maximizing the likelihood is selected among V streams from second step.

Maximizing the likelihood function is equivalent to minimizing Euclidean distance between Y and H·Ŝ^{(v)}. Thus, final decision value can be obtained as

$${\hat{S}}_{final} = arg {min}_{{\hat{S}}^{( v )}} ‖ Y - H \cdot {\hat{S}}^{( v )} ‖ . \qquad [ Equation 5 ]$$

Since this simplified ML technique considers only V candidate streams, much lower complexity is needed than that of conventional ML detection scheme.

The present invention can use any other DFE detectors such as OSIC as well as QR decomposition.

To evaluate the performance of the present invention, V-BLAST system with 16-QAM is considered.

FIG. 5 shows the BER performance of the proposed technique with 16-QAM and Nₜ=Nᵣ=3 according to the number of V. As expected, the more number of V is adopted, the better BER performance is acquired. In the case of V=16, since all L symbols are considered for V candidate symbols, the performances of MMSE and ZF detectors are similar. And since the MMSE detector can suppress the error propagation efficiently, the detectors with both V=8 and V=16 have the same performance.

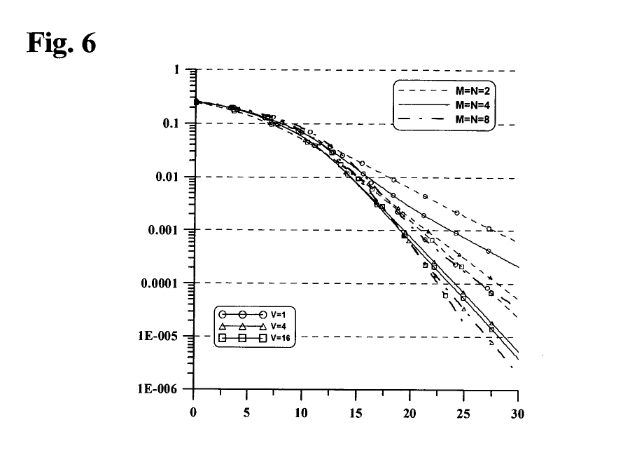

FIG. 6 shows the BER performances with Nₜ=Nᵣ=2, Nₜ=Nᵣ=4 and Nₜ=Nᵣ=8 according to the number of V. The performance enhancement is found according to the increase of V, regardless of the number of transmit antennas. The performance gains of the detection with V=16 and Nₜ=Nᵣ=2 and 4 over the conventional DFE (V=1) are 7 and 5 dB when the required BER is less than 10⁻³. But, the performance gain of the proposed detection with V=16 and Nₜ=Nᵣ=8 over the DFE detection with V=1 is 2 dB when the required BER is less than 10⁻¹. In the case of Nₜ=Nᵣ=2 and 4, the increase of performance is very high, since only one symbol and three symbols are detected according to the first detected symbol. On the other side, in the case Nₜ=Nᵣ=8, since the proposed technique has to detect seven symbols according to the only first detected symbol, the proposed technique has small performance gain.

While this invention has been described in connection with what is presently considered to be the most practical and preferred embodiment, it is to be understood that the invention is not limited to the disclosed embodiments, but, on the contrary, is intended to cover various modifications scope of the appended claims.

1-3. (canceled)

4. A method for detecting a most probable streams from among sub-streams of DFE detector comprising the following steps:
detecting V sub-streams that outputs of DFE detector;
detecting V streams according to the detected V sub-streams and executing a DFE decoding process V times; and
selecting a most probable stream among V streams using a likelihood test.
